(19) United States
(12) Patent Application Publication
(10) Pub. No.: US 2020/0308370 A1
(43) Pub. Date: Oct. 1, 2020

(54) RECYCLABLE OR COMPOSTABLE FILM REPLACEMENTS OF PLASTIC ALUMINUM LAMINATE PACKAGING

(71) Applicant: David Jose Espinosa Duran, Malaga (ES)

(72) Inventor: David Jose Espinosa Duran, Malaga (ES)

(21) Appl. No.: 16/954,222

(22) PCT Filed: Dec. 16, 2018
(86) PCT No.: PCT/IB2018/060155

§ 371 Date: Jun. 16, 2020

Related U.S. Application Data
(60) Provisional application No. 62/729,461, filed on Sep. 11, 2018.
(60) Provisional application No. 62/687,267, filed on Jun. 20, 2018.
(60) Provisional application No. 62/643,205, filed on Mar. 15, 2018.
(60) Provisional application No. 62/609,351, filed on Dec. 22, 2017.

(51) Int. Cl. C08K 9/02; B29C 35/08; B29C 48/00; B29C 48/885; B29C 55/00; B29C 55/04; B32B 27/10; B32B 9/00; B32B 27/30; B32B 37/06; B65D 65/40; C08J 5/18; C08K 3/34

(52) U.S. Cl. CPC C08K 9/02; B29K 2105/203; B29C 48/022; B29C 48/0018; B29C 48/885; B29C 55/005; B29C 55/04; B32B 27/10; B32B 9/005; B32B 27/304; B32B 27/306; B32B 37/06; B65D 65/40; C08J 5/18; C08K 3/346; B29C 2035/0811; B29C 35/0805

(57) ABSTRACT

The invention describes the use of magnetic platelet particles as a multifunctional additive to various formulations of polyolefin plastic films usable to fabricate packaging and to provide said packaging with similar barrier properties as aluminium metallizations or other gas barriers, with the added benefit of allowing separation and recovery of the packaging by magnetic means. Such novel additives, films and packaging are environmentally friendly and food-safe, so that after use they can be either recovered for reuse, composted, or dumped in the environment to biodegrade. The invention comprises various types of films comprising the additive and methods to improve the properties of said films.

### CROSS-REFERENCE TO RELATED APPLICATIONS

This application claims the benefit of U.S. Provisional Applications:
a. No. 62/609,351 filed on Dec. 22, 2017.
b. No. 62/643,205 filed on Mar. 15, 2018.
c. No. 62/687,267 filed on Jun. 20, 2018.
d. No. 62/729,461 filed on Sep. 11, 2018.

The entire disclosures of the above applications are incorporated herein by reference.

### TECHNICAL FIELD

This invention relates to thermoplastic films used to make containers.

This invention also relates to the field of recycling of containers.

This invention also relates to thermoplastic or multimaterial flexible containers with good gas and moisture barrier properties.

This invention also relates to the field of magnetizing.

This invention also relates to recyclable fibers and coatings.

This invention mainly discloses compositions and fabrication methods of recyclable or compostable flexible materials with enhanced magnetic susceptibility and enhanced barrier properties preferably used in the fabrication of containers, fibres or coatings.

### BACKGROUND ART

In many packaging applications, cardboard, adhesives, aluminium and plastics are used layered together as films or coats, known as multimaterial laminates, examples of which are Plastic-Aluminum Laminates (PAL) and cardboard-aluminum-plastic laminates, for example those commercialized under the brand Tetra Brik. The reason to combine layers of different materials is that each one provides specific properties to the package. For example, an aluminum layer, usually a film or a coating, with a thickness ranging from a few nanometers to several micrometers, is used to act as a barrier against moisture and gases such as oxygen or carbon dioxide or odors and also against visible light, ultraviolet radiation or infrared radiation, protecting the contents of the package from the degrading action of these external agents or keeping aroma inside the package.

Several polymer formulations based in polyolefins are known to those skilled in the Art, many of which can be used in this invention. For example, a polymer formulation and film fabrication method suitable to be integrated in this invention is described in patent U.S. Pat. No. 5,043,204A “Oriented polyethylene film”, which text is incorporated herein by reference.

Use of talc or mica as fillers in plastic formulations is quite common. Said mineral fillers are often used to reduce the amount of polymer required, sometimes as electric insulators or more usually as mechanically reinforcing agents, as described for example in patents U.S. Pat. No. 4,080,359A “Talc containing polyolefin compositions”, patent U.S. Pat. No. 5,886,078 “Polymeric compositions and methods for making construction materials from them”, patent U.S. Pat. No. 5,030,662 “Construction material obtained from recycled polyolefins containing other polymers”; patent U.S. Pat. No. 3,663,260A “Talc filled metallizable polyolefins” and U.S. Pat. No. 4,082,880 “Paper-like thermoplastic film”, which texts are incorporated herein by reference.

Use of talc or mica as a filler blended with high density polyethylene and a rubber to fabricate films and containers is described in Patent U.S. Pat. No. 5,153,039A “High density polyethylene article with oxygen barrier properties”, which text which is incorporated herein by reference.

Methods to manufacture containers made from polyolefin sheets containing talc, mica and/or other platy-shaped fillers are known to those skilled in the Art and described for example in patent EP0897948A1 “Polypropylene sheet composition containing mica and talc, containers made therefrom and process for their manufacture”, which is hereby incorporated by reference.

Formulations and fabrication methods for pearlescent or iridescent pigments, used for aesthetic reasons and based in natural or synthesized flat particles made of mica or aluminum flakes coated with one of more layers of metal oxides, are described in patents such as CN101517011A and U.S. Pat. No. 7,678,449B2, which texts are incorporated herein by reference.

Patents US20120261606A1 “Magnetic pigments and process of enhancing magnetic properties” and U.S. Pat. No. 7,678,449 “Iridescent magnetic effect pigments comprising a ferrite layer”, which texts are incorporated herein by reference, disclose magnetic pigments, based in mica particles coated with iron oxides. Said pigments have been proposed in said patents solely for aesthetic purposes, coloring the material or providing it with iridescence, pearlescence or other optical effects.

Patent WO2015018663A1 “Magnetic or magnetizable pigment particles and optical effect layers” discloses magnetic or magnetizable pigment particles than can be magnetically oriented and be used as anti-counterfeit means on security documents or security articles.

The paper “Synthesis of talc/Fe3O4 magnetic nanocomposites using chemical co-precipitation method” by Katayoon Kalantari et al, published on International Journal of Nanomedicine 2013: 8 1817-1823, which text is hereby incorporated by reference, says “[ . . . ] Fe3O4 magnetic nanoparticles were synthesized using the chemical co-precipitation method on the exterior surface of talc mineral as a solid substrate. Ferric chloride, ferrous chloride, and sodium hydroxide were used as the Fe3O4 precursor and reducing agent in talc. [ . . . ]”

Iron oxide nanoparticles can be synthesized and have several applications as described for example in “Synthesis, characterization, applications, and challenges of iron oxide nanoparticles” By Attarad Ali et al, published in Nanotechnol Sci Appl. 2016; 9: 49-67. Said paper describes methods to coat magnetic nanoparticles.

Polymer melt filters are devices used in the recycling of post-consumer or post-industrial plastic items and work by melting plastics and filtering out non-molten materials.

Recyclable compositions of plastics include many formulations as known to those skilled in the art, such as, but not restricted to, those based in polyolefins and polyesters and their derivatives.

Non-biodegradable plastic materials are widely used to fabricate films and fibers with formulations based in both low and high-density polymers such as low density polyethylene (LDPE), high density polyethylene (HDPE), ultrahigh molecular weight polyethylene (UHMWPE), polyethylene terephthalate (PET), polypropylene, copolymer polypropylene, polystyrene, poly(vinyl chloride) (PVC) and ethylene vinyl alcohol (EVOH), all of which are suitable to be used in the hereby disclosed invention as the main constituent of what we will refer to as “polymer formulation” used in the fabrication of plastic films or other items with enhanced magnetic susceptibility.

Biodegradable (compostable and sometimes edible) film formulations used in packages are well described in the literature and represent an active area of research development. They are usually based in thermoplastic polymers such as polylactic acid (PLA), polyvinyl alcohol (PVA), polybutylene succinate (PBS) and polyhydroxyalkanoates (PHA). Thermoplastic films fabricated with said polymers can be decomposed by bacteria or other living organisms and are also suitable to be used in this invention as the main constituent of the “polymer formulation”.

Thermoplastic is to be understood in this text as a plastic material that becomes pliable or moldable above a specific temperature and solidifies upon cooling.

U.S. Pat. No. 6,920,982 “Plastic material having enhanced magnetic susceptibility, method of making and method of separating”, whose full text is incorporated by reference, describes “[ . . . ] a method of enhancing the magnetic susceptibility of a plastic article to facilitate its removal from other material, the method comprising blending a given amount of a magnetic material into a plastic formulation prior to formation of said article, said given amount being small enough so as not to materially affect properties associated with its function while being large enough to alter said magnetic susceptibility of the article [ . . . ]”.

A plastic retort pouch or retortable pouch is a type of food packaging made from a flexible plastic, usually laminated or coated with aluminum. Said pouch allows the sterile packaging of a wide variety of food and drink handled by aseptic processing, and is used as an alternative to traditional industrial canning methods.

The permeability of a film of a given material to a specific gas can be expressed by the amount of a said gas than can cross a unit surface of said material in a given time. It is known that moisture and some gases such as atmospheric oxygen, alone or in combination with other agents such as bacteria and/or light, can negatively affect food and many other packed goods. Thus, to extend the shelf-life of many packaged goods, the packaging must provide an effective barrier against the passage of such gases and agents, reducing the permeability of the film. Other goods, such as coffee, tea or perfumes, also require that the aroma be preserved inside the package, keeping the volatile compounds responsible for the aroma within the package.

The phenomenon of permeation of gases through materials has been extensively studied and depends of various factors, including the thickness of the material, the material chemical composition, its density, its structure and even its molecular arrangement as a glassy or as a crystalline phase and the shape and arrangement of the crystals. In general, dense materials are known to be less permeable, and crystalline phases are also less permeable than glassy ones.

Platy mineral powders used as fillers in plastic film formulations are known to under some conditions reduce the permeability to gases and moisture of said films. The reduction in permeability of the film is usually attributed to what is known as the “tortuous path effect”, which describes the longer path that the gas molecules have to traverse while diffusing through a material, such as a film, when said gas molecules encounter impermeable obstacles in their way, which they circumvent prolonging the length of their path across the polymer, which results in a lower amount of gas crossing the film per unit time.

Regarding the inclusion of platelet particles in films, it is generally believed that the alignment of said particles with their largest face parallel to the film surface maximizes said “tortuous path effect” and thus minimizes gas permeability, compared to a random orientation of said particles.

Mineral powders comprising platelet-shaped particles such as montmorillonite, mica and talc, used as fillers in plastic film formulations, are known in some cases to reduce the permeability of said films, effect attributed to the tortuous path effect. However, the addition of impermeable fillers to plastic formulations, including platy ones, is not enough in many cases to reduce the permeability of films; indeed, sometimes the fillers can even increase gas or moisture permeability of films, as discussed in “How the shape of fillers affects the barrier properties of polymer/non-porous particles nanocomposites: a review” by C. Wolf et al, published in Journal of Membrane Science 556 (2018) 393-418, text which is hereby incorporated by reference.

The permeability to gases of many materials, and of those used to make packages, is well known and there are standard methods to measure it. For example, low density polyethylene (LDPE), which is one of the most used polymers in packaging, show low permeability to moisture, but relatively high permeability to oxygen. Polymers such as EVOH or PVDC, which show very low permeability to Oxygen, are known as “barrier polymers” in the field of plastic packaging and are often included as one or more layers in laminated plastic packaging to compensate for the relatively high permeability to oxygen of other layers, such as LDPE, HDPE, PP or PET that are included for their thermal sealing ability or desired mechanical properties.

Current commercial methods used to reduce the overall permeability of packaging rely on the superposition of continuous layers of materials showing very low permeability to one or more gases. Said layers are selectively used as barriers, to prevent passing of gas molecules across the film.

### SUMMARY OF INVENTION

The invention in its main aspect describes the use of highly impermeable magnetic powders as an additive or active filler comprised in the formulation of or added as a coating over thermoplastic films and laminates used in the fabrication of flexible packaging. Said magnetic particles, included mainly as non-continuous barrier layers in the film structure, are mainly used in the invention to reduce the gas and moisture permeability of said films and containers, and to facilitate identification and separation of a film or container from other materials using a magnet, for example at a recycling plant, also allowing to recover said films or containers from land or a river or from seas and oceans using a magnet.

The magnetic films, sheets and laminates that can be fabricated according to the present invention can be used not only to fabricate flexible packaging, but also to fabricate related elements such as lids, cups, caps, trays and wraps, made with single-layer or multi-layer plastic films and comprising a monomaterial or various materials in a layered structure, to protect goods from gases and moisture, with the advantage and novelty that said plastic packaging have a magnetic behaviour which facilitates their recovery at waste plants and in the environment.

In this text the words “film” and “sheet” preferably refer to items with thickness below one millimeter.

This invention also describes how to reduce the permeability, facilitate processing and complementary improve other properties of films that incorporate the disclosed magnetic additive, said methods made possible by the metallic content or magnetic properties of the particles.

In another aspect of the invention, it describes a method to also improve the recyclability of fibers and protective coatings: said improvement is achieved thanks to the inclusion of the disclosed magnetic additive and the optional and preferable application of novel magnetic-based treatment methods also disclosed, made possible thanks to the inclusion of said magnetic additive.

The effects of the magnetic additive and the novel methods described in this invention can be combined together to further reduce the permeability and complementary modify various other properties of items incorporating the additive; said items preferably comprising films or laminated sheets but also comprising coatings or fibers; said other properties comprising mechanical properties such as hardness and rigidity, and other properties such as transparency, color, printability, electric conductivity and thermal conductivity.

### Technical Problem

Multimaterial laminated packages have outstanding functional properties, which are obtained by combining several layers with micro or nanometer thickness of different materials with complementary properties that enable both light-weighting, flexibility, strength, resistance to scratching and good-to-excellent gas and moisture barrier properties. Unfortunately, multi-layer materials are very hard to recycle due to the varied nature and behavior of the materials involved. Thus, most of multi-material packaging end up in landfills, incinerated or into the environment.

Multimaterial laminates typically combine films, foils or coats of polymers, paper, cardboard and other materials including metals and their oxides such as aluminum, SiOx, AlOx, Al0xNy, indium tin oxide (ITO) and SiNx that are used together in layers, most often joined with adhesives. An important group of multimaterial laminates used in packages are Plastic Aluminum Laminates (PAL), which combine layers of aluminum, adhesives and thermoplastic polymers into flexible multilayered sheets. The main reason to use aluminum, SiOx or a polymer such as ethylene vinyl alcohol (EVOH) or polyvinylidene chloride (PVdC) and their combinations as one or more of those layers is that these materials show low or very low permeability to specific gases, such as O2 and CO2 and/or to moisture, and thus act as a barrier against said gases and/or moisture protecting sensitive contents of the package against these degrading agents or reducing gas leak outside the package, for example to conserve the aroma of the contents. Such polymers are known as barrier polymers. Layers of aluminum and other inorganic materials such as SiOx that provide good gas barrier properties can be applied with thickness as low as a few nanometers through special coating techniques, such as metallization under vacuum.

Examples of packaging geometries that use a barrier layer of aluminum or a barrier polymer together with plastic and other materials such as paper are flexible multimaterial sachets, tubes and pouches such as those used to contain and protect small paper towels, condoms and other hygiene and toiletry items, household and industrial detergents and cleaning chemicals, snacks, coffee and tea powders and grains, pet food, dairy products, meat and fish, fruits, cereals and grains and more generally raw or processed food and beverages. Other examples of use of these laminated multimaterial plastic packages include for example blisters for medicines and as flexible closures for many products. Another example of multimaterial laminated packages are cardboard-plastic (polyethylene)-aluminum packages used to store liquids and commercialized under the brand Tetra Brik.

Another problem of multimaterial packaging is that it is often produced in small size formats, for example sachets containing sauces and other condiments, cookies, chocolate bars, candies, chewing gum, etc. and small drink or food pouches. The small size of these packages makes them more difficult to separate from other waste and recover.

Additionally, their low weight per unit, and thus low economic value per unit, makes them less attractive to be recovered from waste or from the environment.

There's a limitation in the use of barrier polymers such as EVOH and PVDC in certain packaging applications. Polymers containing polar groups, such as polyamides and the most widely implemented material in retortable plastics, the ethylene-vinyl alcohol copolymers, which are the most suitable barrier elements in retortable plastics, suffer from barrier deterioration after retorting heating.

One of the design features that make multi-material packaging hard to recycle is that they include organic or inorganic continuous barrier layers, most often very thin, such as aluminum coatings that are very difficult to separate from other layers.

Additionally, it is known that most optical (infrared) sorting devices experience problems in identifying and separating waste, such as packages, that have aluminum layers.

Replacing packaging designs and materials that are hard to recycle with ones that have been designed and fabricated to be easier to recycle is a crucial intervention to create a more circular plastics economy, where plastics are designed to be reused, recycled or composted, and prevented from ending up as waste in the environment.

As of 2018, very little of multimaterial laminates are recycled and they end up incinerated, in landfills or as accumulating “plastic garbage” on land and sea.

To give an idea of the global scale of the problem posed by multimaterial laminates, it is estimated that in 2017 about five million metric tons of used plastic aluminum laminated packages were incinerated, deposited on landfills or dumped in the environment.

### Solution to Problem

The invention in one of its main aspects discloses an easier-to-recycle alternative to current hard-to-recycle multimaterial laminates and methods to fabricate said alternative. The invention uses a magnetic additive which is added to thermoplastic formulations as a multifunctional filler or is deposited on thermoplastic films or laminates as a coating, in enough quantities to make the packaging comprising such films behave as magnetic and preferably as paramagnetic, so that the packaging or parts of it can be separated from waste using magnets, thus easing recycling of said packaging and also allowing their recovery from the environment using magnets.

The magnetic particles of the additive comprised in this invention, thanks to their impermeable nature, composition, selected geometry, and ordered arrangement into a thermoplastic film, and the novel treatment methods that can be applied to said film thanks to the inclusion of said magnetic particles, provide said film with significantly improved barrier properties to gases and moisture, which allows the fabrication of flexible packaging comprising said film, so that said packaging show reduced permeability to gases and moisture, compared to similar films not comprising the additive. Said magnetic particles can be used in the fabrication of packaging instead of aluminium foil and polymer gas barriers, avoiding the recycling problems associated to aluminium and said polymer gas barriers.

### Advantageous Effects of Invention

The invention herein disclosed describes a more recyclable alternative to current flexible multimaterial plastic packaging. This alternative material allows the fabrication of packaging that are easier to separate from waste, easier to recover from the environment and easier to recycle into new products and that also provide similar or better protection to packaged goods than current multimaterial packaging. By making packages easier to recycle we expect that their economic value will be recovered and that less of them will be incinerated, put in landfills or otherwise end in the environment as a contaminating waste.

The films and layered sheets produced according to the present invention can also be used to fabricate retortable packages. The magnetic additive, based either in platy or spherical substrates composed of minerals of high melting point or of highly crystalline polymer particles can be retorted (heated) without melting. Additionally, the metal content of the magnetic additive increases the thermal conductivity of the package, which facilitates the retorting process by allowing faster and more efficient heat transfer to the package contents. The increased thermal conductivity also facilitates cooking of packaged foodstuff, for example by boiling in water, by allowing faster and more efficient heat transfer from the package exterior towards the food inside the package, reducing energy consumption in the cooking process.

### BRIEF DESCRIPTION OF DRAWINGS

Film thickness is exaggerated for clarity in all drawings. Surfaces refer only to the largest surfaces of films or sheets, not to their section. Terms “parallel”, “perpendicular” and “concentrated” must be understood as “substantially parallel”, “substantially perpendicular” and “substantially concentrated”.

FIG. 1 shows a portion of a plastic film (1) containing as additive the platelet-shaped particles (2) of list A arranged parallel to the film's surface.

FIG. 2 shows a portion of a plastic film (1) containing as additive the platelet-shaped particles (2) of list A arranged parallel to the film's surface and concentrated on the film's surface.

FIG. 3 shows a portion of a plastic film (1) containing as additive the platelet-shaped particles (2) of list A arranged perpendicular to the film's surface and concentrated on the top surface of the film.

FIG. 4 shows a portion of a plastic film (1) with the spherical particles of the additive (2) concentrated on the top surface of the film.

FIG. 5 shows a portion of a three-layers plastic film (1 denotes each layer) containing as additive the platelet-shaped particles (2) of list A arranged in six layers parallel to the film's surface and concentrated on the film's external surfaces and on each of the two surfaces of each of the three layers.

FIG. 6 shows a portion of a three-layers plastic film (1 denotes each layer) containing as additive the spherical particles (2) of list A arranged in six layers parallel to the film's surface and concentrated on the film's external surfaces and on each of the two surfaces of each of the three layers.

FIG. 7 shows a portion of a three-layers plastic film (1 denotes each layer) containing as additive the platelet-shaped particles (2) of list A arranged as three layers, with two layers of particles arranged parallel to the film's surface and concentrated on the layer's top surfaces and the external layer of particles arranged perpendicular to the film's top surface

FIG. 8 shows the result of selective heat treatment of the magnetic particles (2) in the film of FIG. 2. The doted lines (not numbered in the drawing) below the flat particles (2) represent flat polymer crystals.

FIG. 9 represents a film (1) loaded with spherical particles of list B that is monoaxially stretched with the assistance of magnetic fields (3). 9A is the film before stretching and 9B after stretching.

FIG. 10 represents a portion of a plastic fibre composite (1) loaded with the spherical particles of list B concentrated on the fibre's surface. The polymeric matrix is referred to by number 3.

FIG. 11 represents a portion of a plastic composite fiber loaded with magnetic powders similar to that of list B but showing a needle-like geometry instead of a spherical one, with the needle-like magnetic particles arranged parallel to the film surface. The number 3 refers to the polymeric matrix.

### DESCRIPTION OF EMBODIMENTS

The invention discloses a material often referred in this text as “additive ” or “magnetic additive”, which is made preferentially of magnetic platelets, and more preferably of high aspect ratio platelets, but also can be made of magnetic spherical particles or magnetic needle-shaped particles (or “needles”), which are respectively referred in this text as “magnetic spheres” or “magnetic needles”. Said additive can be incorporated by compounding mixing with a thermopolymer formulation or be added as a coating over films or over previous coatings such as protective or decorative paints.

In this text the adjective “magnetic” is used meaning a material or item which behaves as either ferromagnetic, paramagnetic or superparamagnetic and thus can be displaced or rotated by an applied magnetic field or magnetic field gradient, for example using magnetophoresis techniques as known to those skilled in the art. It is to be understood that fragments of said magnetic items will also generally show said magnetic behavior.

For brevity, needle-shaped micro or nanoparticles will be referred to as “needles” within this text. The term “magnetic needles” is used to refer to needles showing a magnetic behavior.

In one aspect of the invention, micro or nanoparticles and in particular those with a platelet, needle-shaped or spherical geometry are made to behave as ferromagnetic, paramagnetic or superparamagnetic by respectively coating them with ferromagnetic, paramagnetic or superparamagnetic compounds.

In another aspect of the invention, said magnetic particles are paramagnetic and preferably superparamagnetic by having attached nanoparticles of magnetite. There are various methods to coat micro and nanoparticles with nanoparticles of magnetite which are known to those skilled in the art.

In another aspect of the invention, the magnetic additive is obtained by a coating method that results in nano or micro-sized particles with superparamagnetic behavior been attached to nano or microparticle substrates; wherein said substrates to be coated with the nanoparticles are preferably nano or micro-sized spheres or platelets or needles, and most preferably nano or microplatelets. Various methods to coat substrates such as talc with magnetite nanoparticles are known to those skilled in the art; one preferred method to obtain talc magnetic microparticles that can be used as the magnetic additive of this invention is described in Kalantari's paper referenced above.

In another aspect of the invention, said coated particles, being magnetic, can be relocated within or over an item by using magnetophoresis techniques as known to those skilled in the Art of microbiology; a substantial number of the magnetic platelets and magnetic needles used in the invention, can also be rotated using said techniques.

In yet another aspect of the invention, the platelets, needles or spheres used to fabricate the magnetic additive, before been coated with selected metals or metal oxides to make them magnetic, are composed of highly impermeable materials and have a non-porous structure that makes said particles highly impermeable to many gases, including oxygen and carbon dioxide and to moisture. The platelets, needles and spheres before and after been coated to make them magnetic show very low permeability to said gases and moisture.

In yet another aspect of the invention, said coated particles, being magnetic, act to focus and concentrate magnetic or electromagnetic fields applied to them, which allows for the local increase of the strength of said magnetic or electromagnetic fields and the accentuation of the local effects derived from said fields.

In yet another aspect of the invention, the inclusion of metals or metal oxides in the composition of said coated particles, results in the occurrence of significative induction-heating effects on said particles when said particles are subject to an alternating magnetic field of selected frequency.

In yet another aspect of the invention, an alternating magnetic field, combined with a non-alternating magnetic field can be used to locally and selectively heat a film or other item comprising said magnetic additive and to also influence the shape or orientation of growing polymer crystals of said film or item located near the magnetic particles, with a significant local accentuation of the effects of said magnetic fields thanks to the presence of said magnetic particles.

In yet another aspect of the invention, the inclusion of metals or metal oxides in the composition of said coated particles results in a significant local or global increase of the thermal and electric conductivities of the items comprising said particles.

In yet another aspect of the invention, the inclusion of iron oxides in the composition of said coated particles result in said particles showing a biocide or biostatic behavior; behavior can also be shown in items comprising said particles.

In yet another aspect of the invention the magnetic particles, comprising the (impermeable) magnetic platelets or (impermeable) magnetic needles are incorporated to a thermoplastic film and are preferentially arranged so that said particles are substantially oriented parallel to the film's surface, which results in hindering gas permeation across said film.

In yet another aspect of the invention the magnetic spheres are incorporated to a thermoplastic item and are preferentially arranged over or near the item's surface, and are preferably incorporated to said film by coating, which results in improved printability of said film.

In yet another aspect of the invention the magnetic particles, comprising the magnetic platelets or magnetic needles are incorporated to a thermoplastic film and are preferentially arranged so that he magnetic particles which are located near the surface of the film are substantially arranged perpendicular to the film's surface, which results in increased hardness.

In yet another aspect of the invention the impermeable magnetic particles are incorporated to a thermoplastic film and said particles are concentrated in selected regions of said film, so that said regions are parallel to the film's surface, which results in hindering gas permeation across said film and reduced permeability of said film.

In yet another aspect of the invention selected magnetic particles with very low permeability to gases and moisture are used as a replacement for continuous aluminum foils or metallizations and/or as replacement of one or more of the gas or moisture continuous barrier layers made of materials such as Al2O3, PVdC or EVOH that are comprised in flexible plastic containers.

In yet another aspect of the invention, items comprising in their formulation or structure said magnetic additive, can hinder gas and moisture permeation across the package walls with similar performance as the continuous barrier layers they replace, thanks to the combination of the gas barrier effect of the impermeable additive particles and the modification of the crystalline structure of the film by the magnetic methods described in this invention.

In yet another aspect of the invention, and differently from most accepted strategies for providing barrier properties in previous Art that use continuous barrier layers or non-magnetic fillers, the magnetic additive particles of the invention form non-continuous barriers to gases that can be separated from post-consumer or post-industrial sheets and packages by first melting or dissolving the package or sheet to make it liquid and then using a magnet to attract the (solid) magnetic additive, with optional filtering, allowing its separation from the molten or dissolved plastic and the recovery of the additive and of the molten or dissolved plastic as separate streams, which facilitates recycling and reuse of both.

U.S. Pat. No. 6,920,982 referenced above only addresses separability of plastic products by increasing their magnetic susceptibility, with no specified effect on the gas-barrier properties of the product. However, the novel invention provides several advantages derived from the addition of platelet-shaped, or spherical magnetic micro or nanosized particles to plastic parts and preferably to films and sheets. Main advantages are increased impermeability (to gases and moisture), separability of the package from waste using magnets and the possibility of recovery of the additive from the molten or dissolved plastic also using magnetic means. Other benefits derived from the use of the magnetic additive include the local increase of magnetic susceptibility of the film around the particles, which allows for the application of various novel magnetism-based treatments to improve the properties of the film. These novel “magnetism-based” treatments are described in more detail elsewhere in this text

Inclusion of inorganic natural or synthetic powders such as montmorillonite, mica, calcium carbonate or hollow or full glass spheres as fillers in plastic film formulations is principally known to advantageously modify some of the properties of the film, such as strength, hardness, or density, as known to those skilled in the Art and as described for example in said patents U.S. Pat. No. 4,080,359A, U.S. Pat. No. 5,886,078 U.S. Pat. No. 5,030,662, U.S. Pat. No. 3,663,260A and U.S. Pat. No. 4,082,880. In another aspect of the invention, when the magnetic additive comprises such mineral powders, it's incorporation to films and other items will also modify the film's properties providing said film with those improvements provided by said powders.

In another aspect of the invention, when the magnetic additive is based in organic or inorganic nano or micro particles known to act as reinforcement or barrier agents in composites, it will happen that films and other items comprising said magnetic additive will generally show similar or better improvements in its properties, and in particular in its mechanical or gas barrier behaviors, as those films and other items made with composites based in said non-magnetic reinforcing agents, thanks to the selective concentration of the magnetic particles using magnetic fields or their magnetically arranged orientation within the film to modify hardness or gas barrier properties where the oriented magnetic particles are located, as shown for example on FIGS. 3 and 7.

In yet another aspect of the invention, the magnetic platelets, magnetic needles or magnetic spheres used in this invention can optionally be coated, for example using the method to coat magnetic nanoparticles described by Ali as referenced above. The optional coat applied to the magnetic particles of this invention serves various purposes, including those described by Ali, and most importantly to decrease agglomeration of said particles, and to protect the underlaying coatings of said particles from chemical oxidation or reduction or to prevent leaching out or mechanical detachment of said particles or their constituents.

In yet another aspect of the invention, high aspect ratio magnetic and highly impermeable platelets are used as a magnetic additive in thermoplastic formulations to fabricate plastic films or laminates or apply said impermeable and magnetic platelets as one or more coatings over films, sheets, over other coatings or over other items. It is also possible as disclosed in this invention to arrange said highly impermeable and magnetic platelets to have their largest surfaces parallel to the surface of the film, which results in a reduction of the film permeability.

Known techniques used to coat films with magnetic particles and applied in the fabrication of magnetic films, such as coating by bath immersion used in the fabrication of magnetic tapes used to record and reproduce music or data, can be adapted to be used for the incorporation of the magnetic additive of this invention and for the orientation of the magnetic particles of the additive over a film using magnetic fields. Said coating and magnetic particle orientation methods of the magnetic tape industry are hereby mentioned to enable the skilled user its adaptation and application to the present invention.

Differently to disclosed methods to fabricate composites comprising oriented magnetic particles as reinforcers, in this invention the added magnetic particles are primarily selected in their composition, shape and structural characteristics for their very low permeability to gases and moisture and are fabricated to preferentially contain a load of magnetic material high enough to allow the film that contains enough of said particles and selected items comprising said film to be lifted by inexpensive commercially available magnets, which allows easy identification and separation of said films and items from waste or to be picked up in the environment using magnets, which makes such items more recyclable.

As yet another aspect of the invention, the magnetic additive particles located within or over an item such as film or coat can be rotated by magnetophoresis techniques similar as those used in the art of microbiology, so that said particles are arranged parallel to the film's surface, which minimizes the permeability of the plastic film. Improvement or modification of the mechanical properties of the film such as strength or hardness is not the main purpose of using the magnetic additive, although said properties can also advantageously and selectively be affected. This is important because a material's design and characteristics that affect its mechanical behavior are different and sometimes contrary to requirements and characteristics needed to minimize its permeability to gases.

In this invention the preferred additive is based in flat particles, non-porous, as thin as possible, that also show an aspect ratio as high as possible, that are preferably aligned parallel to the film's or coat's surface and optionally concentrated in one or more planes. Use of such very thin platelets, which can be brittle, and said parallel alignment of the particles may in some instances have an inappreciable or even negative effect on some of the mechanical properties of the item, for example reducing its hardness or its elongation at break, but it will significantly and advantageously reduce the permeability of said item, which is our preferred attribute.

Complementary, inclusion of metal or metal oxide particles in plastic films is known to advantageously modify some of their properties and provide them with modified features. In yet another aspect of this invention, because the additive has a relatively high content in metal oxides (preferably magnetite), said additive will also provide the film with those advantages and features given by loading it with metals or metal oxides. Such advantages include for example the known bactericidal effect of iron oxides and the increase in the electric and thermal conductivity of the film, which facilitates both industrial retorting of goods and cooking of packaged food.

The additive provides plastic films of any thickness with the advantages of inclusion of both (magnetic) metals and impermeable powders but combined into a single element, the platelets, needles or spheres coated with (magnetic) metals, which allows the separation and recovery of the valuable additive by magnetic means. The additive, loaded with (super)paramagnetic or ferromagnetic materials, is incorporated compounded with thermoplastic formulations or as a coating on preformed plastic films or added to other items such as protective coatings (paints) in enough quantities to provide the film with a magnetic behavior, so that said films or items and their selected fragments, such as a coating paint detached from a wall, can be lifted with an inexpensive magnet.

A superparamagnetic behavior is in general the preferred behavior of the magnetic additive to avoid unwanted sticking of films or laminates or other items containing the additive to items made of ferrous metals, such as tools or processing equipment.

In yet another aspect of the invention, by using the magnetic additive instead of continuous layers of gas-barriers such as aluminum, PVDC or EVOH, we facilitate separation of empty packaging from waste using magnetic means. Additionally, and contrary to the use of continuous barrier layers, the magnetic additive is in particulate form and can be separated from the molten polymer by physical and mechanical means with ease, for example melting (or dissolving) the package and using a magnet to attract and separate the additive from it, without clogging the melter's and other filters. Such magnetic-assisted separation process yields two streams; one containing the magnetic additive, and another comprised of the molten polymer formulation, both of which can be recycled and used as feedstock to produce new items.

In yet another aspect of the invention, the magnetic platelets can be optionally coated to prevent their aggregation and/or improve their adhesion to the polymeric matrix, using dispersing and/or coupling agents such as but not restricted to silanes, maleic anhydride, oleic acid, etc., and/or be treated with techniques to enhance filler-matrix adhesion such as surface activation with plasma. Such dispersing and/or coupling agents are well known to those skilled in the Art and their choice, amount or optimal processing parameters depend on the chemical nature of the dispersed phase (the additive) and of the polymeric matrix.

In yet another aspect of the invention the additive composition, its application method, percentage used and its localization and geometrical arrangement within or over the film are tailored to simultaneously provide two or more benefits to the film, packaging and other items comprising the additive, including reduced permeability, improved printability, anti-blocking of films, modified rigidity or strength, increased or reduced hardness, increased thermal or electric conductivities and antibacterial properties. The additive thus provides the film with the advantages of inorganic platy or spherical fillers such as talc and mica flakes or glass spheres and with the advantages of metallic fillers, and with the advantages made possible by their magnetic contents, but with the added benefit of providing those advantages thorough the use of a single additive, the magnetic (metal-loaded) additive.

The invention is not a simple combination of two existing solutions (use of mineral fillers such as mica and talc and of metal additives such as iron oxides). The invention, by loading ferromagnetic or paramagnetic or superparamagnetic metals into the particles, alters the behavior of said particles, so that they become susceptible to magnetic forces, which facilitates their separation and recovery from the liquid (dissolved) or molten polymer. This allows for example the use of very small-sized particles as the additive, for example under 50 microns average size of particles (D80), size that would be difficult or impossible to industrially separate from a liquid or molten plastic matrix by filtration, as such particle sizes are in general smaller than filter pores of industrial filters and thus are not retained during filtration, but can be separated (with magnets) from the molten polymer after filtration thanks to the magnetic nature of the additive.

In yet another aspect of the invention, because the additive is magnetic, a magnetic force can be used during fabrication of the item containing the additive, or as a post-fabrication treatment, to arrange the additive particles in a selected and ordered manner, for example to concentrate them in selected locations within or over said item to modify the properties of the item.

Putting the magnetic (metallic) material over the platelets also gives the sheet a different behavior than adding the platelets and the magnetic metal as separate entities. Indeed, such arrangement (platelets covered with magnetic material) does not only allows recovery of the filler using magnets, but also influences how the material responds to applied magnetic fields. For example, it allows for the application of two methods based in the application of magnetic fields, methods that are later described in this text to modify the crystalline characteristics of the polymer, rendering the film less permeable to gases.

In the invention, talc is the preferred material to be used to fabricate the additive. Talc, which is inexpensive and generally regarded as safe, has an index of refraction similar to that of the polymer to be preferably used in this invention, polyethylene (PE), and can thus be used with it compounded as if it were a common filler or applied as a coating to produce films that show fair transparency. On the other hand, if we coat talc particles with a magnetic iron oxide the resulting coated particles will be less transparent.

In yet another aspect of the invention, one preferred variant of the additive are high aspect ratio talc or montmorillonite microparticles or nanoparticles coated with superparamagnetic magnetite nanoparticles. Because such additive is less transparent in a polymer (PE) matrix than the non-coated platelets, the film itself will be less transparent. If good film transparency is desired, the magnetic platelets can be displaced and concentrated into specified locations using a magnet, allowing passage of light elsewhere. Because such additive concentration can lead to increased gas permeability where there is less additive, a formulation of additive can be produced to include a fraction of the platelets with none or with a very little amount of the magnetic coating, low enough to not significantly modify the index of refraction of the platelet and to not be affected by the magnetic field used to relocate the additive for better transparency. Various mixtures of particles, some showing high magnetic susceptibility and other with low magnetic susceptibility can be formulated and various magnetic field gradient patterns applied to move some of the particles and concentrate them in patterns within or over the film, which results in films with different transparencies, but still showing high overall impermeability to gases thanks to the inclusion of platelets with a low amount of or no magnetic coating.

In yet another aspect of the invention the magnetic platelets needles or spheres, which have a different index of refraction of light than the film, can be arranged in the film in 2d or 3D patterns thanks to the use of externally applied magnetic fields, to produce optical effects through light interference phenomena, in a similar way as is done with mica-based magnetic pigments as known to those skilled in the Art. To apply a magnetic field as a mesh pattern, 2d or 3D magnetized metal wire meshes placed near the film can be used.

The additive, referred in this invention as “magnetic platelets” or “magnetic flakes” is not actually restricted in its substrate composition to talc or mica powders, but can include other “flat particles” with an “aspect ratio” (diameter/thickness) of at least five, and preferably above twenty, with different chemical compositions and/or structure showing very high impermeability to gases and moisture and that are not currently considered toxic or dangerous. Such platelets can be inorganic or organic and be made of minerals such as those of the mica and talc families, clay minerals such as montmorillonite, chlorite and their derivatives and also of materials such as aluminum, glass such as soda-lime or borosilicate glass, ceramics, graphene, micaceous iron oxide, and highly crystalline organic materials with high melting point such as those made of polyetheretherketone (PEEK) or polyphenylene sulfide.

The “magnetic additive” provides two or more benefits to materials comprising it; said benefits comprising: (A) acting as a barrier against gases, moisture and electromagnetic radiation in selected regions of the UV, microwave, visible or infrared wavelengths; (B) allowing identification and separation of the package by a magnetic force; (C) improvement of printability properties; (D) visual effects, including colors and effects such as pearlescence or iridescence; (E) locally altered mechanical properties, such as increased rigidity or increased or reduced hardness, (F) bactericide or bacteriostatic effects due to the presence of iron oxides, (G) increased thermal conductivity, (H) increased electric conductivity, which reduces accumulation of static charge on the film, (J) improved processability of films, including antiblock effects and (I) local increase of magnetic susceptibility allowing the application of novel “magnetic treatments” on the films and package. Which properties are provided by the additive and to what degree depends on the amount of additive used, its composition, how it is arranged within the film (location and orientation) and if the film has been subject to one of the “magnetic treatments” later described.

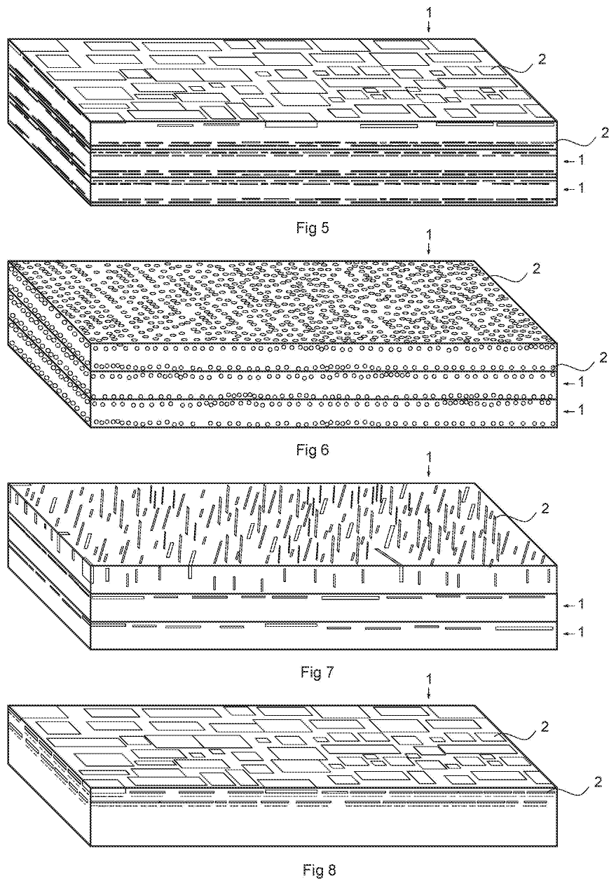

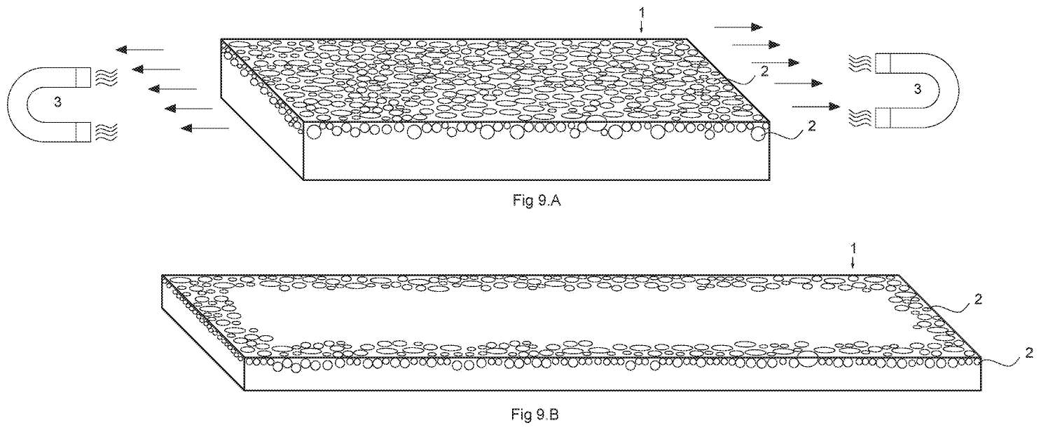

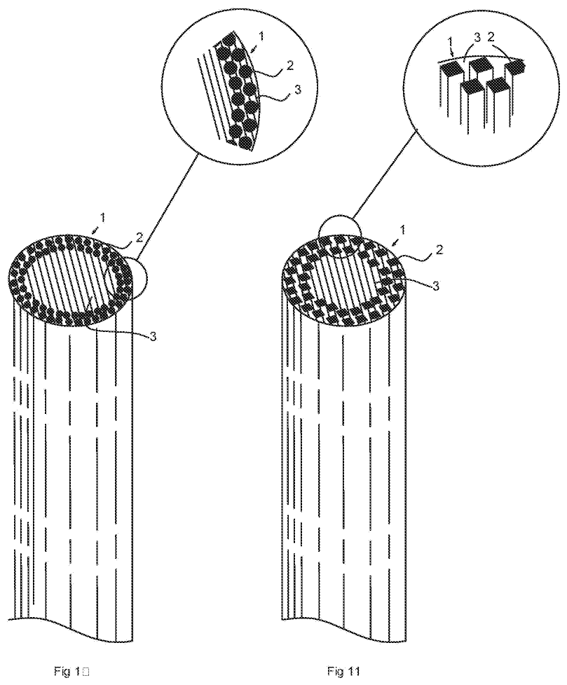

The inclusion of the magnetic particles allows the use of magnetic forces to rotate the particles of the additive (using magnetophoresis techniques) so that said magnetic particles, and in particular those with a platelet shape or a needle shape become arranged parallel to the surface of the film or fiber (FIGS. 1, 2 and 5), or fiber (FIG. 11) which maximizes their barrier effect on gas and moisture permeation compared to using randomly arranged platelets or needles.

The application of the magnetic additive to recyclable polymers formulations or as a coating allows the fabrication of permanent magnetic or non-permanent but magnet-attractable (paramagnetic) films and mono or multimaterial laminates made with said films that can be used alone or combined with other materials (such as other polymer films, paper or cardboard) to fabricate containers with high barrier properties and easier to recycle (thanks in part to their magnetic behavior) than multimaterial laminates containing aluminum layers.

In the preferred embodiment, small flat particles (platelets) with high impermeability to gases and moisture, preferably made of talc and optionally made of other mineral platy powders such as those comprising mica, montmorillonite, micaceous iron oxide (MIO), and their mixes with sub-millimeter size, are preferably coated with superparamagnetic nanoparticles of magnetite and alternatively with one or more magnetic or ferromagnetic or paramagnetic metals, such as iron and its paramagnetic or ferromagnetic compounds and their combinations, including for example Fe, FeO and Fe3O4. Loading said mineral particles with these metals and oxides can be done preferably by depositing layers of the metals and oxides over the largest surfaces of said particles and more preferably by a co-precipitation method using iron salts, deposition method known to those skilled in the art, to preferably result in a multitude of superparamagnetic nanoparticles or aggregates of said nanoparticles attached as a coating over said platelets. Said platelets coated with the magnetic metals are used as an additive to polymeric formulations to produce plastic items, preferably but not limited to thermoplastic films, preferably by an extrusion method, and more preferably by blow extrusion. Said plastic items or selected parts of them behave as magnetic, and preferably as (super)paramagnetic thanks to the inclusion of the magnetic additive and thus can be attracted by a magnet with enough force to allow separation of said item or of its fragments from waste or their recovery in the environment using magnets.

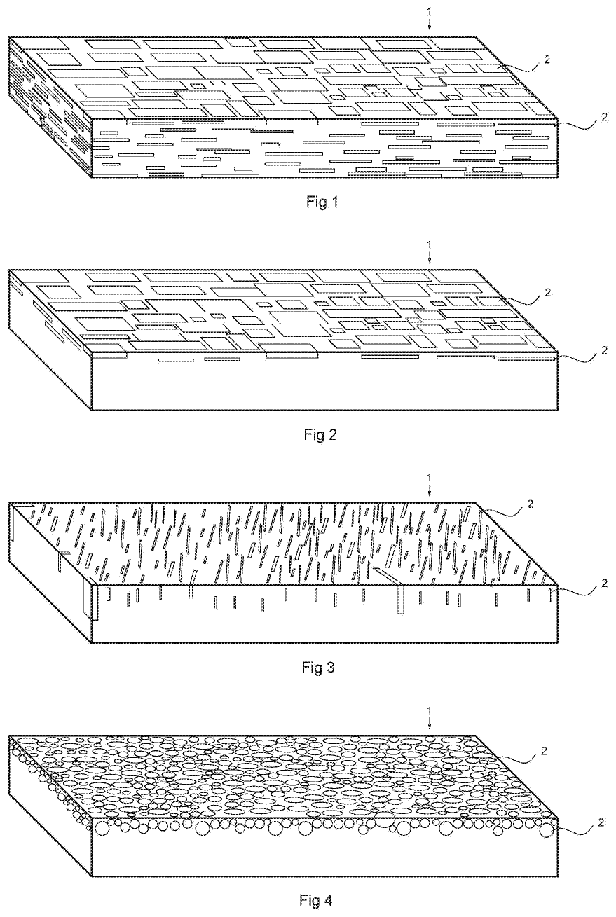

In another embodiment films containing the magnetic platy additive can be arranged in layers that are laminated together, and said films are preferably based in polyolefin formulations compatible for recycling as known to those skilled in the art, preferably said films comprising LDPE, HDPE or UHMWPE. LDPE allows packaging sealability and UHMWPE has relatively high gas barrier properties and high strength, while HDPE has intermediate properties and facilitates adhesion between LDPE and UHMWPE if used as an intermediate layer. Even more preferably the magnetic additive will be concentrated in planar regions of each layer wherein said regions are preferably orientated parallel to the film's surface; even more preferably said platelets will be arranged with their largest faces parallel to the film surface, as shown on FIGS. 1 and 2. Methods that allow for the concentration of the platelets and their orientation parallel to the film surface are described later in this text.

In the preferred embodiment the additive is incorporated to the film preferably by bath submersion coating after film extrusion and alternatively by mixing it with the polymer formulation in a screw extruder as known to those skilled in the art.

In another preferred embodiment films comprising the magnetic additive are arranged in layers that are laminated or coextruded together. Said films are preferably based in polymer formulations comprising only materials that are generally considered as compatible in mechanical (melting) recycling as known to those skilled in the Art. Even more preferably, the magnetic additive will be based in magnetic spherical micro or nanoparticles, of diameter preferably at least ten times smaller than the thickness of film they are incorporated into. Said spheres will be preferably concentrated in planar regions of the film (FIG. 4) or layer (FIG. 6) wherein said regions are preferably oriented parallel to the film's surface. Methods that allow for the concentration of said magnetic spheres in selected regions of the film are described later in this text.

In yet another embodiment, the inclusion of the magnetic particles allows the use of alternating magnetic fields as a selective heating method, methods usually known as “induction heating”, thanks to the inclusion of a high metal content in the additive composition, so that the additive increases its temperature when subject to an alternating magnetic field of selected frequency. The metal in the additive act as a focus point for electromagnetic radiation, which allows for example sealing containers that incorporate the “magnetic additive” using existing induction heat-sealing technologies.

In yet another embodiment, the inclusion of magnetic metals, preferably attached to the platelets or as stand-alone particles is used coupled with inductive heating of said particles to locally modify the crystalline structure of the polymer. This can be achieved by first heating and partially melting only the regions of the plastic around the additive particles using induction heating techniques similar to those currently applied to inductive heat-sealing of containers. Once the molecules of the heated polymer are free enough to move, some of them will rearrange orderly into crystals, with said crystals growing physically limited by the nearby flat platelets. The presence and flat geometry of the magnetic particles thus advantageously influences crystal growth of the heated polymer, resulting in the creation of flat or needle shaped polymer crystals near and parallel to the magnetic platelets.

In yet another embodiment, an alternating magnetic field is applied as a treatment to laminate two or more films together. The additive is applied or incorporated as one or more layers over plastic films containing the additive, and inductive heating is used to selectively heat and melt only the regions of the plastic films that are close to the additive, which allows to partially melt and bind the films together to laminate them without using an adhesive compound, simplifying the packaging composition which facilitates recycling.

In another aspect of the invention, two overlapped magnetic fields can be applied as a treatment to modify the properties of a film comprising the additive. An alternating magnetic field is used to inductively-heat the additive contained in a plastic film and a non-alternating magnetic field is used to influence the growth of the polymer crystals; optionally and preferably a magnetic field can be used to rotate the platelets and align them with their largest faces in parallel. To influence growth of a polymer crystal using a magnetic field usually it is required that a static magnetic field of great strength be used;

however, the included magnetic particles act greatly concentrating the magnetic field around them, which allows to achieve said influence on crystalline growth but using a much weaker external magnetic field that if the magnetic particles were not present. To maximize such “magnetic field concentration” effect, it is most preferred that the magnetic particles show a superparamagnetic behavior, which is achieved by using micro or nanoparticles coated with superparamagnetic magnetite or a magnetic compound with similar behavior.

In yet another embodiment we selectively heat the magnetic particles by inductive heating, so that the polymer near the heated particles is brought to a temperature near its melting point and we then cool the film either fast or slowly to achieve different local effects on its structure and characteristics, for example achieving higher crystallinity (slow cooling) or lower crystallinity (fast cooling), which affects both its mechanical (for example elasticity) and gas-barrier behavior.

In yet another embodiment we fabricate a film with enhanced properties by first applying the additive as thin coatings between two or more, and preferably five or more layers of plastic films made of LDPE, HDPE, UHMWPE, or PP , and use an induction-heating or similar non-contact heating device that will heat preferentially metals, to heat the additive and the surrounding polymer to temperatures above the melting point temperature of said polymer, which allows the re-arrangement of the polymer molecules. Once the heating field intensity is substantially reduced, we can let the plastic that is closer to the additive to slowly cool down to solidify with more crystallinity than the rest of the plastic that has not been so heated and softened because it is located further away from the hot additive particles, resulting in regions of the film with different degrees of crystallinity and thus with different mechanical behavior and different barrier properties, as shown on FIG. 8.

In another preferred embodiment a bi-laminated film is produced incorporating the magnetic platelets additive. Where the additive particles are located, after magnetic induction heat-treatment the polymer will show a different crystalline profile than the other regions of the film, which does not have the additive and thus have not been so affected by the heat irradiating from the induction-heated platelets. Such bi-layer structure with an intermediate coating of the magnetic platelets can be repeated by laminating together several layers of the film, with the additive concentrated in regions within or over said films, and the laminated films be induction-heated one or more times to produce a “monopolymer” laminate with intermediate layers of the additive and alternating zones of higher and lower crystallinity, and with flat polymer crystals formed near the flat platelets of the additive, as shown on FIG. 8.

In yet another embodiment a magnetic field is applied to a plastic film (that has been loaded with the magnetic additive) while it is near or above its melting point temperature, to influence the direction of crystalline growth. A magnetic force can not only be used to displace (magnetophoresis), rotate and arrange the additive particles as desired, but has also been shown to influence the direction of crystalline growth in some polymers such as poly(ethylene naphtalate) (PEN) as described by Wang in “Magnetic Field Induced Growth of Single Crystalline Fe3O4 Nanowires” published in Advanced Materials Volume 16, Issue 2. This novel enhancement treatment of plastic films, which we call “Metal-Enhanced Crystal Growth Magnetic Conditioning” (or MECG for short), can be performed for example following these non-comprehensive steps, and be applied to sheets or films loaded or coated with the magnetic additive:
a. Optionally heating the thermoplastic film to a temperature below and near its melting point, reducing its viscosity.
b. Subjecting the film to an alternating (oscillating) magnetic field of frequency between 100 kHz to 1000 kHz, and preferably between 300 kHz to 600 kHz to rapidly heat by induction the metallic particles in the additive and heat the surrounding material by conduction from the heated particles, locally reducing the film viscosity and putting the polymer in contact with the heated particles above its melting point.
c. Optionally applying a magnetic field to the film while the sheet is hot and has reduced viscosity to rotate the flat magnetic particles and arrange them perpendicular to the sheet surface to facilitate displacement of the particles in that direction.
d. Optionally applying a magnetic field to the film, while the film is hot and has reduced viscosity, to displace the flat magnetic particles and concentrate them in one or more planes.
e. Optionally applying a magnetic field to the film while the film is hot and has reduced viscosity, to rotate the flat magnetic particles and arrange them with their largest surface parallel to the film's surface to reduce the sheet permeability.
f. Applying a magnetic field parallel to the film while the film or regions of it are at temperatures above its melting point, to influence the shape of the growing crystals and produce highly impermeable flat polymeric crystals parallel to the film's surface that reduce the overall sheet permeability.

MECG method, of which several variants will be apparent to those skilled in the art, shows various advantages and its steps can be repeated or modified in their order to achieve different effects. For example, in the method inductive heating of the platelets allows to selectively heat them very fast, compatibly with industrial processing of films, so that only the polymer surrounding said platelets reaches its melting point. This allows to rotate or displace the heated magnetic (and partially metallic) platelets over or within the film, as if they were hot knives cutting through butter, and to arrange them parallel to the film surface, without so much heating the rest of the film and thus without compromising the overall integrity of the film. The steps of this embodiment can be comprised and adapted to the other embodiments of the invention that describe magnetic-based methods used to modify the properties of films, laminates and other items comprising the magnetic additive.

The inclusion of magnetic platelets in the film significantly increases the local intensity and thus the influence of an externally applied magnetic field on crystalline growth during cooling, by concentrating the magnetic field inside and around those flat magnetic particles, allowing the growth of flat or needle-shaped crystals, especially in the regions of the film closer to the additive, where the magnetic field is concentrated because of the metallic composition and magnetic behavior of the platelets' coating. This local focusing of the magnetic field into the platelets allows for the use of much lower values of the external magnetic field to achieve said influence on crystalline growth. Comparing two polymeric films with equal composition and degree of crystallinity, the polymer in which the polymer crystals are flatter and arranged parallel to the surface of the film will show much lower permeability rates to gases than another polymer of same composition and same degree of permeability but with its polymer crystallites shaped in non-flat geometries. This is because crystalline phases have lower permeability than glassy ones. Thus, for the main intended application (flexible packaging) a magnetic force applied near the film in a direction that results in flat polymer crystals arranged in parallel to the film surface can be applied while the polymer is not yet consolidated, in order to influence crystalline growth in the shape of flat polymer crystals growing parallel to the film surface, which maximizes the gas barrier properties compared to other crystal shapes and orientations. Such effect on crystalline growth greatly benefits from the inclusion of the metal (magnetic) particles, arranged parallel to the film surface, by the concentrating effect of the magnetic field of said particles.

Thus, the invention also provides an innovative method to increase the barrier properties of a film that has been loaded with the magnetic additive so that the additive particles have been arranged parallel to the film surface. The method consists in the application of a magnetic force to a film (loaded with the additive) while the polymer is locally (around the particles) above its melting point, to influence recrystallization of the polymer into flat crystals, instead of the spherical ones that would have resulted without the additive and without the applied magnetic force. The direction and intensity of the magnetic field and the cooling rate can be adjusted to control the extension and direction of crystalline growth.

In yet another embodiment, we produce a film with improved properties containing the additive. First, we put the additive in the middle of a bi-laminated film (coating a film with the additive and laminating it with the same polymer) and arrange the additive particles flat to the surface using a magnet either during film fabrication or as a posterior treatment. We can rapidly heat the bi-layered film by induction, rotate and optionally relocate and concentrate the particles in a surface parallel to the film surface using magnetophoresis and cool it down, to obtain a non-homogeneous composite film in which the polymer at its middle is loaded with a flat layer of additive particles, wherein said particles are aligned with their largest faces parallel to the film surface, and wherein said particles are surrounded by a polymer layer, also parallel to the film surface, showing a relatively high degree of crystallinity, showing flat polymer crystals that are also parallel to the film surface; an overall arrangement of flat magnetic particles and flat crystals which results in reduced permeability of the film compared to a similar materials to which a magnetic treatment has not been applied. Said material shows a sandwich structure and will be more flexible in the external regions of the film, which are less crystalline or with a more random crystalline arrangement, and that is more rigid and less permeable in its middle, where it is more crystalline and with its polymer crystals more orderly arranged.

It is to be noted that the flat shape of the platelets is important and beneficial because, once selectively heated, they irradiate the heat into the surrounding material with the irradiated heat wave showing a flat local profile that follows the particle's shape. If the platelets are arranged in a plane, then the heat wave irradiated from the heated (hot) particles also shows a plane profile. Thus, by arranging the platelets on one or more parallel planes, and by selectively heating (induction heating) said particles, we can produce a plane profile irradiating from the plane where the hot platelets are located. We can use this flat heating profile to modify the polymer characteristics resulting in an anisotropic material (film) with a layered structure (structure that follows the heat-wave profile) with gas-barrier and mechanical properties varying along its thickness. If we arrange the platelets in surfaces perpendicular to the film, and selectively heat the platelets, and slowly cool the film then we will obtain a film whose mechanical and gas barrier property vary in directions perpendicular to the film surface.

In yet another embodiment, we arrange the platelets on one or more planes within or over the film and apply a static magnetic field to the film. The magnetic platelets will strongly concentrate the applied magnetic field inside and around them, so that the combined effect of the platelets so arranged is to concentrate the magnetic field on the same plane where the magnetic platelets are located. This is used in this embodiment to influence crystalline growth near the platelets, first placing the platelets on a plane, and then applying a magnetic field parallel to said plane and while the film has reduced viscosity, so that said field, concentrated by the particles, affects crystalline growth, resulting in polymer crystals growing parallel to the magnetic field near the platelets.

In yet another embodiment, a product obtained according to this invention is a cardboard-plastic laminate, in which the plastic is formed by one or more polymers that are compatible for recycling, that have been loaded with the additive. Preferably, the additive particles will have been arranged as parallel to the surface of the packaging by magnetophoresis and preferably the polymer will have been induction-heated and recrystallized under a magnetic field disposed so to induce (re)crystallization of the polymer into flat crystallites parallel to the surface of the film to maximize its gas barrier properties. Such cardboard-plastic laminate would represent an improvement over aluminum-cardboard-plastic laminates as it requires no aluminum layer and allows recovery of the barrier element (additive) by heating the package to melt the film and then applying a magnet to attract and recover the magnetic particles from the molten or dissolved plastic. The inclusion of the additive will also provide the packaging with other benefits as already disclosed, allowing for example a significant reduction of thickness or even total elimination of the cardboard layer used thanks to the increased stiffness of the plastic layer provided by the additive.

Biodegradable thermoplastic packages (including those compostable and/or edible) that incorporate the magnetic additive can be easily separated, regardless of size or weight, from other materials (typically at a waste separation/management facility) using magnets, and thus be recovered and valorized or dumped in the environment to naturally degrade without any major negative effects. The additive can also be recovered from the package by melting it and applying a magnetic field to capture the magnetic additive.

In yet another embodiment, the novel magnetic additive described in this invention, although created for its preferential use in films used to make flexible packaging, is applied in the fabrication of items such as bottles, trays or lids or to thicker elements such as caps, with the additive providing improved barrier properties, stiffness and mechanical strength to said items, allowing the application of the magnetic treatment methods disclosed in this invention and also allowing separability and improved recyclability of such items by magnetic means.

The invention, contrary to some others previously disclosed that use mica coated or not with iron oxides, uses platy, needle-shaped or spherical powders not only as a filler, reinforcement or for a visual effects, but as an active additive or coating with various functions, included in a proportion and arrangement in the film or other item (such as a fiber or a protective coating) that results in enhanced impermeability to gases and moisture and improved recyclability by magnetic separation from other items, and thus the magnetic powders are not just used as an inert filler or mechanical reinforcement and/or just for giving coloring, pearlescence or other visual effects.

Another advantage of the invention is that the magnetic additive can be separated from its polymeric matrix by melting the plastic package and then using magnetic means to recover the magnetic powders, which further facilitates recyclability or composting, and allows for a more circular use of materials, less waste, and overall reduced costs.

In a variant of the invention, mechanically reinforcing fibers, organic or inorganic, including fiberglass, fused silica, ceramic, graphite, etc., as known to those skilled in the art, can be added to the formulation of plastic films. Such fibers will also be preferably coated with a magnetic material if their after-use recovery or separation by magnetic means is desired. These fibers, if coated to be magnetic, can optionally be arranged in parallel to the film surface to reduce its gas permeability and can be used in combination with the magnetic platy additive or alone, depending on the application requirements.

The invention also comprises a method to align the magnetic mica particles based in inductive heating of a coating. In the method, a plastic film is first coated with the magnetic platelets, for example by spraying or by a roll coating method. The coat is then selectively heated by induction under an oscillating magnetic field. The metallic layers or nanoparticles deposited over each platelet act as individual antennae, concentrating the alternating magnetic field, are heated by this concentrated field (heating attributed to magnetic hysteresis losses in the platelets) and transmit heat into their close surroundings, including the plastic film by conduction. Because of this heat, the plastic film softens around the metallic part of each platelet. The radiation intensity frequency and duration can be controlled so that only the film in direct contact with the metal oxides softens around it, with the overall effect that only the platelets that are parallel to the film surface become attached to it. Once the radiation is removed, some of the platelets will be now attached to the plastic substrate, and in particular those where their metal coating is in closer contact with the film surface. The film can then be shaken, blown, washed or brushed to either remove completely the non-attached particles or to rearrange them with respect to the film substrate, so that some of the loose platelets become parallel and with their metallic part in contact with the film substrate. The process can be repeated several times, adding more additive of same of different characteristics, until most of the particles are attached to the substrate and are arranged parallel to it. It is to be noted that most of the metal coat of the platelet has been deposited on their largest exposed surfaces.

The invention also comprises another novel method to modify the behavior of films that have been loaded with the magnetic additive. Said method, which we call “Magnetic Axial Orientation” (MAO) can be compared in its effects to what is known as the “axial orientation” commonly used in the production of materials such as biaxially oriented polypropylene (BOPP) and polyester (BOPET) films used in packaging. The novel method, of which several variants are possible, and which can be combined with or replace current mechanical (bi)axial orientation methods, takes advantage and is possible thanks to the inclusion of the magnetic additive in the film. The novel method, in its simplest practical implementation applies two parallel and strong magnetic fields to the film, preferably while the film has reduced viscosity, so that the magnetic particles (additive) which have preferably been dispersed homogeneously within the film, are magnetized and attracted by the external magnetic fields. The externally applied magnetic fields can be displaced, attracting the additive and forcing the film to stretch as the additive particles are displaced. To be effective, the film must be at a temperature low enough not to allow displacement of the particles with respect to the film, but high enough so that the film has enough elasticity to allow stretching. The magnetic forces can be complemented with the mechanical methods currently used in axial orientation techniques.

Alignment of the magnetic additive to the substrate is most important with respect to the gas barrier properties (impermeability), which are maximized when the largest surfaces of the platelets are parallel to the substrate.

The influence of the additive in the optical behavior of the film depends of various factors, including the chemical composition of the polymer and of the platelets, the amount and type of metal incorporated to the additive, the location and orientation of the flakes and the amount of additive used, so that it will be possible to produce a wide range of film transparency values depending on those factors.

In an example of application of the invention, we coat or “decorate” high aspect ratio (HAR) talc, mica or montmorillonite nano or microparticles with superparamagnetic magnetite nanoparticles and incorporate about 1% to 50% in volume of this flaky magnetic additive to a formulation of polyethylene, preferably LDPE, HDPE or UHMWPE, mixing them in a screw extruder. A composite film can be then extruded. Induction heating can be applied while and/or after the film is formed to selectively heat the flakes and its surroundings, locally heating the film above its melting point and reducing its viscosity. A magnetic field can be used to rotate the flakes and set them parallel to the film surface. Such an arrangement of the flakes results in higher gas barrier properties compared to randomly arranged flakes but in reduced transparency compared to a polymer without a metallic load. Once the flakes are arranged in the desired orientations and locations, the magnetic field can be maintained to induce the formation of flat crystals while the polymer is above its melting point.

If we want to increase transparency of the film carrying the magnetic additive, we can use a magnetic field, applied as a spatial pattern near the film, during induction heating of the film to move and concentrate the additive in spots or lines that follow the applied magnetic pattern, allowing better light transmission where there is no or little additive.

In another example of application, a film can be produced comprised of several individual layers carrying the additive, from just two to a dozen or more, using laminating or coextrusion techniques as known to those skilled in the Art. The additive can be concentrated in thin sections (planes) in each layer of the laminated film using magnetophoresis with said planes parallel to the film surface to minimize permeability by the combined barrier effect of each layer of additive. In the outer layers of the laminate, a layer with a parallel arrangement of the flaky additive with respect to the film surface results in reduced permeability and improved printability but a perpendicular arrangement of said flakes results in increased hardness.

The invention comprises the additive, film and laminates containing the additive, treatment methods to modify the behavior of films carrying the additive and articles such as packages, bottles, cups and all kind of containers made with said films, modified films according to the disclosed treatments and packaging comprising these elements. Said treatment methods, including use of magnetic fields and optional inductive heating as described, can also be applied to the fabrication and modification of thermoplastic fibers, for example to be used in clothes or another textile uses. Similarly as the film application case, the magnetic additive particles can be arranged inside or over the thermoplastic fibers using magnets, resulting in similar modified properties as used with films (FIGS. 10 and 11).

Alignment of the magnetic platelets to the substrate is most important with respect to the gas and moisture barrier properties, which are maximized when the platelets are parallel to the substrate. The increase of impermeability due to said aligned platelets can be further enhanced for some polymer formulations loaded with the additive if a magnetic field is applied to the molten polymer so that crystalline growth occurs with flat crystals growing arranged parallel to the film surface. Both effects, impermeability by the additive particles, and increased impermeability of the oriented crystalline phase compared to the glassy state or to randomly oriented crystalline phases, complement each other to result in the overall high barrier effect that is claimed.

The platelet additive (powder) mentioned in this text is made from one or a mix of the particles in lists A or B.

List A: flat particles showing very low permeability to gases and moisture and with average diameters between 50 nanometres and 50 micrometres composed of one or a mix of the following: talc, montmorillonite, mica, micaceous iron oxide, chlorite, alumina, silica, silicon dioxide, graphene, graphene oxide, soda-lime glass, borosilicate glass and highly crystalline organic materials with high melting point such as those composed of polyetheretherketone (PEEK) or polyphenylene sulphide, with a particle thickness to diameter ratio value (aspect ratio) of at least five and preferably at least twenty, with said particles having a coat of magnetite, ferro-silicon or another ferrous metal with ferromagnetic, paramagnetic or superparamagnetic behaviour. Said coat is preferably formed by a multitude of superparamagnetic nanoparticles of any shape, alone or aggregated, strongly attached to the largest surfaces of the flat particles and in enough amount that the particle they are attached to can be rotated and displaced by a magnet when submerged or in contact with a highly viscous fluid in a manner controllable by the strength of the magnet and how the magnetic field is oriented or displaced with respect to the particle. Said particles, and preferably mica, talc and aluminium flakes, can be optionally coloured with techniques as known to those skilled in the Art of mineral pigments.

A variant of the additive, called “variant B”, is based in the use of the spherical particles comprised in list B. Variant “B” provides the same properties and advantages of the version based in platelet particles that do not depend on the platy shape of the additive particles, and adds some benefits due to the spherical geometry. Benefits of the spherical geometry of the magnetic particles used in variant B of the invention include:
a. More homogeneous behavior;
b. Reduced viscosity of the molten composite (molten plastic formulation plus solid magnetic additive), allowing higher proportion of additive while maintaining processability (extrusion) into a film;
c. Possibility to reduce the density of the film by using hollow spheres;
d. Higher maximum theoretical packing density of the spheres, compared to randomly oriented non-spherical particles. Higher packing density may result in lower permeability because there are less “openings” (filled with polymer) between the impermeable particles.

List B: spherical particles showing high impermeability to gases and moisture and with average diameters between 50 nanometers and 50 micrometers composed of one or a mix of the following: alumina, silica, silicon dioxide, oxide, soda-lime glass, borosilicate glass and highly crystalline organic materials with high melting point such as those composed of polyetheretherketone (PEEK) or polyphenylene sulfide, with said particles having a coat of magnetite, ferro-silicon or another ferrous metal with ferromagnetic, paramagnetic or superparamagnetic behavior. Said coat is preferably formed by a multitude of superparamagnetic nanoparticles of any shape, alone or aggregated, strongly attached to the surface of the particles and in enough amount that the particle they are attached to can be displaced by a magnet when submerged or in contact with a highly viscous fluid in a manner controllable by the strength of the magnet and how the magnetic field is oriented or displaced with respect to the particle. Said particles, can be optionally colored with techniques as known to those skilled in the Art of mineral pigments.

Films carrying the spherical magnetic particles of list B can be layered or laminated with films carrying the platy magnetic additive of list A to produce laminates or coextruded sheets with different characteristics.

In a preferred embodiment a powder selected from list A is used as the “magnetic platelet additive” described in this text. Said magnetic additive is compounded in a twin screw with a LDPE formulation and other additives (coupling agents, color concentrates, pigments, antioxidants, lubricants, nucleating agents, antistatic agents, etc.). The screw extruder provides a mixing action to effectively cause the wetting and dispersion of the magnetic filler and additives into the polymer matrix. The extruder is used to produce pellets that are blown-extruded or molded into a film-shape of below 200 microns of thickness, and preferably between 15 and 50 microns. The preferred amount of magnetic additive in the film being 5% to 50% in weight. The amount of additive in the film and the amount of magnetic material coating the platelets are calculated so that the mass of magnetic material (deposited on the platelets), is enough to produce a magnetically-liftable film, which means that the film incorporating the magnetic additive can be lifted from the ground using a common permanent magnet of less than 2 tesla. Said magnetically-liftable film is then optionally and preferably subject to any of the magnetic treatments to reduce its permeability described in this text. Said treatments preferably include selective heating of the magnetic particles in the film by induction using an oscillating magnetic field. The film is also subject to a rotating magnetic field to arrange the magnetic platelets parallel to the film surface. Said magnetic treatments are of enough intensity and duration so that until at least a 50% and preferably at least an 80% of the magnetic platelets have been arranged parallel to each other, and preferably have been also arranged parallel to the film surface. Said film is used to fabricate flexible packaging or rigid containers and their accessories such as lids, caps and labels with reduced gas permeability and that can be lifted using a common permanent magnet of about less than 2 tesla.

In another embodiment a plastic magnetic film is first produced as described in the preferred embodiment, but using the additive from List B. The spherical magnetic particles in the film are then selectively heated by induction using an oscillating magnetic field. The film is also subject to a magnetic field to displace at least a 70% of the magnetic additive and concentrate it in a volume representing less than a 70% of the film's total volume. This film carrying the magnetic additive is then laminated with two or more similar films. Magnetic induction heating can be optionally used to facilitate the joining of the layers. The result product is a “monopolymer” plastic laminate composite with two or more intermediate layers of magnetic additive, said laminate having reduced gas permeability and in particular reduced oxygen and moisture permeability compared with a sheet of similar thickness and composition but not using the magnetic additive.

Said plastic laminate can be used to fabricate packaging showing reduced oxygen and moisture permeability that can be lifted with a commercial magnet.

In another embodiment paper or cardboard are laminated with one or more plastic films produced according to the preferred embodiment, to produce a plastic-paper laminated sheet with reduced gas permeability and that can be lifted using a common magnet of about less than 2 tesla. Said laminate can then be used to fabricate containers such as bottles of any shape to contain liquids or solids.

The above and other embodiments of the invention in its various aspects are presented in more detail as the following examples

### EXAMPLES

### Example 1

Following the description of the preferred embodiment, a magnetically-liftable thermoplastic film comprising magnetic talc powders as magnetic additive is produced. Said additive, made of talc powder coated with a 50% in weight of magnetite nanoparticles, is compounded with a low-density polyethylene (LDPE) formulation, incorporating about a 10%-20% in weight of additive. A film of 20 microns thickness is blow extruded. Said film is optionally subject to an oscillating magnetic field to selectively heat the magnetic and metallic content of the film by induction to a temperature of about 110° C.-130° C. and optionally slowly cooled to allow crystal nucleation and growth around or near the platelets.

### Example 2

A polyethylene plastic sheet is coated with the additive of the preferred example, and said additive is inductively heated by a magnetic field oscillating at about 450 KHz until said additive partially melts its surroundings and becomes attached to the film surface. The particles can be shaken to rearrange the loose ones until they are parallel and with their hot metallic coating in close contact with the film's surface, which results in local melting of the film in contact or close to the hot metallic parts of the particles. Because the metallic coating is mostly located in the largest surface of the particles, this process results in only those particles that are parallel to the film becoming attached to it and substantially parallel to the film's surface.

### Example 3

The plastic sheet of Example 1 is subject to three magnetic fields to reduce its permeability to gases:
a. An alternating magnetic field at a frequency of about 450 kHz that heats the additive particles by induction, so that the film surrounding said heated particles is also heated by the heat emitted by the heated additive, to temperatures near the melting point of the film
b. A fixed magnetic field parallel to the film surface
c. A rotating magnetic field applied to rotate the platelets so that they are rearranged as parallel to the film's surface

### Example 4

Another version of the additive is produced in which each platelet particle is coated with a much lower amount of magnetic material so that a much stronger magnetic field is required to displace them and so that less of a 20% percent of the particle's surface and preferably less than 5% is coated by the (dark) magnetic coating. In this example plastic films carrying a mix of two additives with high and low magnetic loads is used to produce the packaging. The film carrying or coated with the additive is subject to a fixed magnetic field arranged in a geometric pattern, for example as lines or in a grid parallel to the film surface, with an applied magnetic field gradient intensity on the film resulting in only those particles with a higher load of magnetic nanoparticles been displaced by the applied magnetic field. The film after the treatment shows higher transparency and the platelets with higher magnetic loading are concentrated in the same geometric pattern as the applied magnetic field.

### Example 5

A plastic sheet or film is produced and treated similarly as in Example 1 but using the magnetic spherical particles of list B as the additive.

### Example 6

Two or more layers of the plastic films of previous examples are laminated together, using intermediate adhesive layers when required or preferably using intermediate coats of the additive between each layer of the polymer and applying inductive heating to heat said particles and partially melt the surrounding polymer by the heat irradiated from the particles while pressing the layers together, for example using hot rolls, so that they become joined by the molten layers. The layered film is then optionally stretched between heated rolls to reduce its rugosity and produce film orientation along the orientation axis.

### Example 7

A magnetic field gradient is applied to a PE or PP film carrying the additive, with the additive particles preferably made of a hard material such as alumina coated (or “decorated”) with magnetic nanoparticles. Said magnetic field gradient is applied in a manner (magnetophoresis), to arrange the particles perpendicular to the film surface, resulting in increased film hardness. Said plastic film with increased hardness will preferably be laminated with others showing lower permeability and based in the same polymer (polyethylene) to achieve overall low permeability but allowing recovery of the plastic and of the additive using a magnet.

### Example 8

Is similar to example 3 but based on the use of PP, HDPE or UHMWPE as the main component in the formulation of the plastic film. Such film, made and treated as described in example 7, can be used as a retortable package with good recyclability (can be recovered using magnets) that does not include an aluminum gas-barrier layer.

### Example 9

A polypropylene film, loaded with homogeneously distributed magnetic additive, preferably made of particles in list B, is subject to the magnetic axial orientation process described previously in this text, resulting in an axially (magnetically) oriented propylene film, loaded with the magnetic additive. Said film can be additionally coated with the magnetic platelets additive, and the process of example 2 be applied to arrange the platelet particles parallel to the film surface to reduce permeability.

### Other Examples

Other examples of films can be made based in the use of a biodegradable thermopolymer formulations (based in PVA, PHA or PLA), loaded or coated with the magnetic additive and subject to similar treatments as in the previous examples to fabricate biodegradable films with reduced permeability. Said films can be recovered from waste using magnets and from which the additive can be recovered by melting or filtration using a magnet to capture the additive.

Various devices can be developed to implement and industrially apply the methods disclosed in this text, including devices that apply the methods to reduce permeability using magnetic fields, devices to separate packaging loaded with the magnetic additive from waste or to recover the additive from the packaging or its accessories or to apply the novel magnetically assisted film axial orientation method. Said devices will preferably take advantage of the metallic and/or magnetic behavior of the additive and the film, package, lids or other items produced that carrying the additive. Said devices have too many variants to be described in this text.

The above examples do not give a comprehensive and exhaustive “step by step” recipe of fabrication of a film or laminate, because any missing steps (compounding, extrusion, lamination, cooling of the film, construction and sealing of packaging, etc.) can be filled in by anyone skilled in the art of film extrusion of thermoplastics and flexible packaging making. Instead, we have provided an overview of the several possibilities of how the novel methods, based in the magnetic or metallic properties of the additive, can be applied to improve thermoplastic films, leaving to the skilled person the choice of to combine said novel techniques with known techniques of film and package fabrication and treatments, according to the basic characteristics of the polymer formulation which condition which fabrication and processing methods of the films, fibers or other items that incorporate the additive are best suited.

The films according to the present invention can optionally contain antioxidants, antistatic agents, lubricants, inert fillers, ultraviolet ray absorbers, nucleation agents, antiblocking or antislip agents, dispersing agents, colouring agents, etc. in addition to the above described main polymeric constituents, as part of what has been called “polymer formulation”.

The above examples are given to give an idea of how the invention can be implemented. The examples are non-exhaustive because the method allows for the production of many plastic films or sheets, as single layers or as laminates through selecting the base thermoplastic polymer, the composition, shape (platy, spherical or needle) average size and size distribution of the additive, load of metallic (magnetic) nanoparticles, how the additive is incorporated to the film (masterbatch mixed or coating) and the choice of posterior treatments of the film by magnetic methods to reduce permeability and optionally improve other of its properties (printability, hardness, transparency, etc.) as has been described in this text and that will apparent to those skilled in the art.

### INDUSTRIAL APPLICABILITY

The skilled person will realise how the novel methods described in this text can be applied at an industrial scale in the fabrication and modification of items such as films, laminated or coextruded sheets, coatings, fibres, bottles and accessories such as lids and caps and be used in combination with existing industrial equipment and processes to obtain and improve said items.

What is claimed is:

1. A material having improved barrier properties and increased magnetic susceptibility; wherein said material is preferably used as a packaging material; wherein said material, which is referred within this text with the name “magnewall-A”, comprises:
(a) a thermopl ash c polymer formulation; wherein said polymer formulation preferably comprises a polyolefin or mix of polyolefins; and
(b) a given amount of magnetic entities; wherein the term “magnetic” means in this text a ferromagnetic, paramagnetic or superparamagnetic behaviour, wherein at least a 40% in weight and preferably at least an 80% in weight of said magnetic entities are particles or aggregates of particles selected from “List A”; wherein at least an 80% in weight and preferably at least a 95% in weight of said magnetic elements have a diameter of less than 500 μm and preferably less than 50 μm; and
(c) optionally comprises a given amount of cyclodextrin or a derivative of cyclodextrin; wherein said cyclodextrin or derivative is included for its gas barrier properties and is compatible with said polymer formulation and with said magnetic elements;
wherein the amount of the magnetic entities comprised in the magnewall-A is large enough to increase the magnetic susceptibility of the material so that selected objects comprising said material can be lifted with a magnet of less than 5 tesla and preferably less than 1 tesla;
wherein the magnewall-A preferably has an oxygen permeability of less than about 500 cc/100 cm2/day, and more preferably less than 100 cc/100 cm2/day; wherein said material optionally also comprises reinforcing fibres with a melting point or decomposition temperature above about 250° C., of organic or inorganic nature, preferably made of one or more of the following materials: cellulose, lignin, ceramics, graphite, soda-lime glass or borosilicate glass; wherein said reinforcing fibres are preferably coated with a magnetic material;
List A: substantially comprises needle-shaped or preferably platelet-shaped particles or their aggregates showing enhanced magnetic susceptibility and very low permeability to gases and moisture and with average diameters of said particles or aggregates between about 10 nanometres and about 50 micrometres; wherein at least a 90% of said particles or aggregates have a thickness-to-diameter ratio value (aspect ratio) of at least 5 and preferably at least 20; wherein each of said particles or aggregates comprises a substrate and a coat; wherein said substrate is selected from:
(a) talc, montmorillonite, mica, phlogopite, micaceous iron oxide, chlorite, alumina, silica, silicon dioxide, graphene, graphene oxide, soda-lime glass, borosilicate glass, high density polyethylene, or ultrahigh molecular weight polyethylene; or
(b) a highly crystalline organic material with melting point above 220° C. and preferably said crystalline organic material comprising in its formulation polypetheretherketone or polyphenylene sulphide or their mixes;
wherein said coat comprises magnetite, ferro-silicon or another metal or compound with a magnetic behaviour; wherein said coat is preferably formed by a multitude of superparamagnetic nanoparticles of any shape, alone or aggregated; wherein said coat is mostly located over the largest surfaces of the particles or aggregate of particles; wherein preferably the magnetic coat attached to a particle or aggregate is of such geometric distribution over the particle or aggregate and in enough quantities that the particle or aggregate or particles they are attached to can be rotated or displaced by a magnet of less than 5 tesla and preferably less than 1 tesla; wherein said particles or aggregates, and preferably those comprising mica, talc or aluminium flakes as substrate, can optionally show specifically selected colours or can optionally show visual effects such as pearlescence; wherein said magnetic particles or magnetic particle aggregates are optionally coated with one or more additional coatings; wherein said additional coatings preferably prevent detachment, oxidation or reduction of one or more of the coatings applied to said substrate or protect said substrate from mechanical damage or oxidation or reduction; wherein such additional coatings preferably comprises oleic acid.

2. A material having improved barrier properties and increased magnetic susceptibility; wherein said material is preferably used as a packaging material; wherein said material, which is referred within this text with the name “magnewall-B”, comprises:
(a) a thermoplastic polymer formulation; wherein said polymer formulation preferably comprises a polyolefin or mix of polyolefins; and
(b) a given amount of magnetic entities; wherein the term “magnetic” means in this text a ferromagnetic, paramagnetic or superparamagnetic behaviour; wherein at least a 40% in weight and preferably at least an 80% in weight of said magnetic entities are particles or aggregates selected from “List B”; wherein optionally said magnetic entities also comprise particles or aggregates selected from “List A”; wherein at least an 80% in weight and preferably at least a 95% in weight of said magnetic entities have a diameter of less than 500 μm and preferably less than 60 μm;
(c) optionally comprising a given amount of cyclodextrin or a derivative of cyclodextrin; wherein said cyclodextrin or derivative is included for its barrier properties and is compatible with said polymer formulation and with said magnetic elements;
wherein the amount of the magnetic elements comprised in the magnewall-B is large enough to increase the magnetic susceptibility of the material so that selected objects comprising said material can be lifted with a magnet of less than 5 tesla and preferably less than 1 tesla;
wherein the magnewall-B preferably has an oxygen permeability of less than about 500 cc/100 cm2/day, and more preferably less than 100 cc/100 cm2/day; wherein said material optionally also comprises reinforcing fibres with a melting point or decomposition temperature above about 250° C., of organic or inorganic nature, made of materials such as cellulose, lignin, ceramics, graphite, soda-lime glass or borosilicate glass; wherein said fibres are preferably coated with a ferromagnetic or paramagnetic material.
List B: substantially comprises spherical particles or their aggregates showing very low permeability to gases and moisture and with average diameters of the particles between 50 nanometres and 50 micrometres composed of one or a mix of the following: alumina, silica, silicon dioxide, oxide, soda-lime glass, borosilicate glass or highly crystalline organic materials with high melting point such as those composed of polyetheretherketone (PEEK) or polyphenylene sulphide; wherein said particles have a coat of magnetite, ferro-silicon or another ferrous metal with ferromagnetic, paramagnetic or superparamagnetic behaviour; wherein said coat is preferably formed by a multitude of superparamagnetic nanoparticles of any shape, alone or aggregated, strongly attached to the surface of the particles and in enough amount that the particle they are attached to can be preferably displaced by a magnet when submerged or in contact with a highly viscous fluid in a manner controllable by the strength of the magnet, the magnetic gradient and how the magnetic field is oriented or displaced with respect to the particle. Said particles, can be optionally coloured using techniques as known to those skilled in the Art of mineral pigments.

3. The material of claims 1 or 2, wherein said material is used as a protective coating or is used to fabricate fibres.

4. A thermoplastic film comprising the magnebarrier A or magnebarrier B materials of claim 1 or claim 2, wherein said thermoplastic film is usable in the fabrication of flexible packaging or rigid containers and their accessories; wherein at least a 30% in weight and preferably at least a 70% in weight of said platelet-shaped particles of List A are arranged substantially parallel to each other; wherein most of said needle-shaped magnetic particles of said List A that may be comprised in said material are preferably arranged substantially oriented in the same plane.

5. A method to produce the film of claim 4 wherein said method comprises the following steps:
a. Fabricating, preferably by a method comprising extrusion, or alternatively preferably by a method comprising moulding, a plastic film comprising a 1% to a 60% and preferably a 5% to 40% in weight of particles of List A; wherein said film also comprises a thermoplastic polymer formulation which preferably is a polyolefin formulation; wherein said particles are preferably mixed with the polymer formulation in a screw mixing device before extruding the film and alternatively or complementary said particles are applied as a coating over a pre-formed film;
b. optionally subjecting said film or selected parts of it to a temperature near its melting point, reducing its viscosity;
c. optionally subjecting said film or selected parts of it to a magnetic field gradient of between 0.001 to 5 GT/m and preferably between 0.05 to 2 GT/m, while the film or selected parts of it are near its melting point, and preferably while only the regions of the film in contact with said particles are near and preferably above the melting point of said regions, and using said magnetic field gradient to rotate the nearby magnetic particles of List A and substantially arrange them oriented parallel to the same plane; wherein said particles may be located in one or more parallel planes.

6. The film of claim 4 wherein said platelet-shaped or needle-shaped particles are arranged substantially parallel or substantially perpendicular to the film's surface.

7. A method to produce the film of claim 6, wherein said method comprises the steps of the method of claim 5; wherein the magnetic field of step (c) of said method of claim 11 is applied with a field gradient value and direction that results in arranging the magnetic particles so that they become parallel or perpendicular to the film's surface.

8. The film of claim 6 wherein said film has been treated with a method comprising the use of one or more magnetic fields to advantageously modify the properties of said film.

9. A method to produce the film of claim 8, wherein said method comprises the steps of claim 5; wherein said method additionally comprises one or more of the following additional steps:
a. Applying to the film or selected parts of it an alternating magnetic field of frequency between 100 kHz to 1000 kHz, and preferably between 300 kHz to 600 kHz, to rapidly heat by induction the metallic elements and notably the flat or needle-shaped magnetic particles and heat its surrounding by the heat emitted by the heated particles, reducing the film viscosity and putting the nearby polymer near and preferably above its melting point temperature, resulting in a flat or needle-shaped heating profile that follows the particles' shapes, wherein said heating profile influences crystalline growth and results in polymer crystals growing with a substantially flat or needle-shaped geometry; or
b. subjecting said film or selected parts of it to a non-rotating magnetic field while said film or regions of it are near and preferably above its melting point to influence the shape of the polymer crystals growing near the particles of list A and produce polymer crystals substantially growing in the direction of said magnetic field;
c. applying a magnetic field, and preferably a rotating magnetic field, to said film, while the film or selected parts of it is hot and has reduced viscosity, to displace the magnetic elements and the optionally included magnetic fibres and substantially concentrate them in one or more regions of the film, wherein said regions represent at least a 1% and less than a 60% of the item's volume; wherein one or more of said regions are preferably arranged parallel to the film's surface; wherein said regions preferably have a substantially flat aspect;
d. subjecting said film to a magnetically-assisted film-stretching method resulting in controlled axial orientation of the film; wherein said method comprises: while the film is hot, or selected regions of it are hot, applying one or more magnetic field gradients to attract the magnetic particles in the film and displace said particles and said plastic film together, resulting in an elongation of the film in one or more directions according to the directions of the applied magnetic field gradients; wherein said elongation is preferably performed in two perpendicular directions in the plane of the film; wherein said magnetically-assisted stretching can optionally be performed with one or more ends of the film being fixed; wherein said magnetically- assisted stretching can optionally be performed in combination with a non-magnetic stretching method of previous Art; wherein said stretching results in similarly or better advantageous modifications of the film's properties as can be achieved by axial machine orientation methods of previous Art.

10. An item comprising the material of claim 1 or 2, wherein at least a 20% of said magnetic entities of said claims are located in one or more regions of the item; wherein said regions represent at least a 1% and less than a 60% of the item's total volume; wherein at least a 20% of said optional reinforcing fibres of said claims are optionally located in one or more regions of the item; wherein said regions represent at least a 1% and less than a 60% of the item's total volume; wherein said particles of claim 1 can be optionally arranged parallel to each other and be preferably parallel to the item's largest surface: wherein said item is preferably shaped as a film; wherein said item can alternatively be the protective coating or fibre of claim 3.

11. A method to produce the item of claim 10, wherein said method comprises the following steps:
a. Fabricating, a plastic item comprising a 1% to a 60% and preferably a 5% to 50% in weight of particles of List A; wherein said item also comprises a thermoplastic polymer formulation which preferably is a polyolefin formulation.
b. Subjecting said item or selected parts of it to a temperature near its melting point, reducing its viscosity.
c. Applying a magnetic field, and preferably a rotating magnetic field, to said item, while the item or selected parts of it is hot and has reduced viscosity, to displace the magnetic entities and optional reinforcing magnetic fibres and substantially concentrate them in one or more regions of the item, wherein said regions represent at least a 1% and less than a 60% of the item's volume; wherein one or more of said regions are preferably arranged parallel to one of the item's surfaces; wherein said regions preferably have a substantially flat aspect.
d. Optionally subjecting said item or selected parts of it to a magnetic field gradient of between 0.01 CT/m to 5 0.01 GT/m and preferably between 0.5 to 2 0.01 GT/m, while the item or selected parts of it is near and preferably above its melting point, and preferably while only the regions of the item in contact with said particles are above the melting point of said regions, and use said magnetic field gradient to rotate the nearby magnetic particles of List A and substantially arrange them oriented parallel to the same plane; wherein said particles may be located in one or more parallel planes.

12. A laminated sheet preferably used to fabricate packaging; wherein said sheet comprises two or more layers; wherein said layers comprise films according to claim 4, 6, 8 or 10; wherein said sheet optionally comprises an intermediate layer or layers of one or more adhesives; wherein said sheet does not comprise a layer of aluminium with a thickness over 1 μm; wherein said sheet optionally comprises one or more of the following:
a. one or more layers made of a thermopolyrner film comprising less than a 2% of the magnetic particles of List A or List B;
b. one or more layers made of paper, and preferably Kraft paper, or cardboard
c. one or more layers comprising a barrier polymer, preferably based in EVOH or PVdC;
d. one or more layers or coats of a gas barrier material, wherein said barrier material preferably comprises SiOx or Al2O3.

13. A method to produce the laminated sheet of claim 12 wherein said method comprises the following steps:
a. Fabricating, preferably by a method comprising extrusion or alternatively by a method comprising moulding, two or more of the films of claim 4, 6, 8 or 10;
b. optionally using one or more layers of:
i. one or more adhesives:
ii. thermopolymer film comprising less than a 2% of the magnetic particles of List A or List B;
iii. paper, and preferably Kraft paper, or cardboard;
iv. a film or coating comprising a barrier polymer, preferably based in EVOH or PVdC;
v. a film or coating of a gas barrier material, wherein said barrier material preferably comprises SiOx or Al2O3;
c. putting the surfaces of the films or layers we want to join partially or totally in contact, preferably under pressure and preferably between rolls;
d. heating the surface of said films or layers or selected regions of said surfaces to a temperature near their melting points;
e. optionally subjecting said films, or the parts of said films we want to join, to an alternating magnetic field of frequency between 100 kHz to 1000 kHz, and preferably between 300 kHz to 600 kHz to rapidly heat by induction said magnetic particles and any metallic particles or metallic parts included in said selected regions; wherein the heat irradiated from said particles preferably melts totally or in part the surroundings of said particles;
f. optionally using a magnetic field to displace some of the magnetic elements and concentrate them near the film's surface while the material is hot, wherein said field is applied before or during the previous induction-heating step.
g. combining the previous steps to join the films by the effects of heating and optional applied pressure

14. A method to join and form a thermal joint between two similar or dissimilar items for example to make them larger, or for example to join one item with another item to fabricate another item such as a flexible packaging or a rigid container or a part of said packaging or container, or to otherwise modify said items; wherein said thermal joint is made by putting in contact and heating two surfaces that are part of or that are attached to each of said items; wherein said items comprise the material of claim 1 or 2 located near said surfaces to be joined; wherein said method comprises:
a. Putting in contact the surfaces to be joined, preferably under pressure; wherein one or both of said surfaces belong to a part comprising the entities of claim 1 or 2;
b. optionally heating said surfaces to be joined or selected parts of them to temperatures near their respective melting points, reducing their viscosity;
c. optionally using a magnetic field gradient to displace some of the magnetic elements of claim 1 or 2 and concentrate them near said surfaces to be joined while the material is hot, wherein said field is applied before or during the following induction-heating step;
d. subjecting said surfaces, or selected parts of them, to an alternating magnetic field of frequency between 100 kHz to 1000 kHz, and preferably between 300 kHz to 600 kHz: wherein said magnetic field influences any nearby magnetically susceptible materials; wherein said influence on said susceptible materials results in significantly heating said materials; wherein said nearby susceptible materials comprise the magnetic entities of claims 1 and 2; wherein said nearby susceptible materials once hot become sources of heat; wherein said sources of heat raise the temperature of selected parts of their surroundings to values near or above the melting points of said surroundings; wherein said surroundings comprise at least parts of the surfaces to be joined; wherein said heated surfaces or parts of them to be joined are in contact and become partially molten and fuse together joining the items;
e. combining the previous steps to join the films by the effects of healing and optionally applied pressure.

15. An item being a flexible packaging or rigid container of any shape including but not limited to bags, pouches, tubes, cans, brick-shapes, cups, bottles, bowls, trays, dishes or a complement to said packaging or containers, such as lids and caps, usable to store, protect and/or carry goods, wherein said item comprise one or more walls; wherein one or more of said walls comprise at least one magnetic layer; wherein said magnetic layer is a film according to claim 4, 6, 8 or 10 or the laminate sheet of claim 12; wherein said item or parts of it shows a magnetic behaviour allowing that said packaging, once substantially empty, be lifted or otherwise sorted using a magnetic field of less than 5 tesla and preferably less than 1 tesla; wherein said item or parts of it preferably shows a paramagnetic or superparamagnetic behaviour; wherein said item or parts of it preferably shows a reduced permeability to oxygen and to moisture.
